(19) United States
(12) Patent Application Publication
(10) Pub. No.: US 2018/0154562 A1
(43) Pub. Date: Jun. 7, 2018

(54) RESIN MOLDED ARTICLE AND METHOD FOR PRODUCING SAME

(71) Applicant: DENSO CORPORATION, Kariya-city, Aichi-pref. (JP)

(72) Inventors: Hiroyuki YAMAKAWA, Kariya-city (JP); Ryosuke IZUMI, Kariya-city (JP)

(21) Appl. No.: 15/577,811

(22) PCT Filed: May 12, 2016
(86) PCT No.: PCT/JP2016/002313

§ 371 Date: Nov. 29, 2017

(30) Foreign Application Priority Data
Jun. 26, 2015 (JP) 2015-128801

(51) Int. Cl. B29C 45/14; B29C 65/02; B29C 71/04; C08J 5/12

(52) U.S. Cl. CPC B29C 45/14467; B29C 45/14418; B29C 65/028; B29C 2035/0838; C08J 5/12; C08J 2300/22; C08J 2300/24; B29C 71/04

(57) ABSTRACT

A resin molded article includes a thermosetting resin member and a thermoplastic resin member sealing a sealed surface of the thermosetting resin member. An exposed surface of the thermosetting resin member is exposed to an outside of the thermoplastic resin member. An additive having a functional group is added to the thermoplastic resin member. The thermosetting resin member has a surface layer on at least a part of the sealed surface, and the surface layer is made of a thermosetting resin higher in concentration of a carboxyl group or concentration of a phenol group than the underlying thermosetting resin. The carboxyl group or the phenol group present in the surface layer is chemically bonded to the functional group present in the additive.

### CROSS REFERENCE TO RELATED APPLICATION

This application is based on and incorporates herein by reference Japanese Patent Application No. 2015-128801 filed on Jun. 26, 2015.

### TECHNICAL FIELD

The present disclosure relates to a resin molded article in which a part of a surface of a thermosetting resin member is sealed by a thermoplastic resin member and the remaining part of the surface of the thermosetting resin member is exposed to an outside of the thermoplastic resin member, and a method for producing such a resin molded article.

### BACKGROUND ART

Up to now, a resin molded article has been proposed as the resin molded article of that type (refer to, for example, Patent Literature 1), and the resin molded article includes a sealed component which is formed of a substrate or the like on which a component is mounted, a thermosetting resin member made of a thermosetting resin for sealing the sealed component, and a thermoplastic resin member made of a thermoplastic resin for sealing a surface of the thermosetting resin member. In this case, the thermoplastic resin member seals a sealed surface which is a part of the surface of the thermosetting resin member, and exposes an exposed surface which is the remaining part of the surface to an outside.

Such a resin molded article takes the respective advantages: the thermosetting resin is preferable in view of a high adhesion to the sealed component and a low stress property; and the thermoplastic resin is preferable in view of the facts that a molded article is high in dimensional accuracy and toughness. For example, examples of such thermosetting resin are an epoxy resin and the like, and examples of such thermoplastic resin are PPS (polyphenylene sulfide), PBT (polybutylene terephthalate) and the like.

A general method for producing the resin molded article will be described below. First, a curing molding step of coating a sealed component with a thermosetting resin material which is a raw material of a thermosetting resin member, and heating and curing the thermosetting resin to form a thermosetting resin member, i.e. a primary molding is performed.

Next, a plastic molding step of performing an injection-molding so as to coat a sealed surface of a surface of the thermosetting resin member with a thermoplastic resin material which is a raw material of the thermoplastic resin member, thereby heating and forming the thermoplastic resin member, i.e. a secondary molding is performed. In this way, a resin molded article is obtained.

### PRIOR ART LITERATURE

### Patent Literature

Patent Literature 1: JP 3620184 B2

### SUMMARY

However, in such a resin molded article, since an adhesion of the thermoplastic resin to the thermosetting resin is poor, separation tends to occur at an interface between the thermosetting resin member and the thermoplastic resin member.

In the resin molded article of this type, as described above, the sealed surface which is a part of the surface of the thermosetting resin member is sealed by the thermoplastic resin member, but the exposed surface which is the remaining part of the surface is exposed to an outside of the thermoplastic resin member.

For that reason, when separation occurs at the interface, external moisture, contaminants, and so on penetrate into an inside of the resin molded article along the interface from, for example, a portion of the interface exposed to an external, in other words, penetrate from an end portion of the interface located at a boundary between the sealed surface and the exposed surface of the thermosetting resin member.

To cope with such separation at the interface, in the prior art publication described above, after the thermoplastic molding step, another filler is placed at the end portion of the interface located at the boundary between the sealed surface and the exposed surface to coat the end portion of the interface so as to prevent the interface from being separated. However, in this case, since the filler needs to be used separately, there is a possibility that a shape of the resin molded article is restricted and the cost is increased, and so on.

The present disclosure has been made in view of the above points, and it is an object of the present invention to improve adhesion between a thermosetting resin member and a thermoplastic resin member in a resin molded article where a part of a surface of the thermosetting resin member is sealed by the thermoplastic resin member.

According to a first aspect of the present disclosure, a resin molded article includes a thermosetting resin member made of a thermosetting resin, and a thermoplastic resin member made of a thermoplastic resin and sealing a sealed surface which is a part of a surface of the thermosetting resin member. An exposed surface which is a remaining part of the surface of the thermosetting resin member is exposed to an outside of the thermoplastic resin member. An additive having a functional group is added to the thermoplastic resin member. The thermosetting resin member has a surface layer on at least a part of the sealed surface, and the surface layer being made of a thermosetting resin higher in concentration of a carboxyl group or concentration of a phenol group than the underlying thermosetting resin. The carboxyl group or the phenol group present in the surface layer is chemically bond to the functional group present in the additive.

According to the above configuration, the surface layer of the sealed surface of the thermosetting resin member which is in direct contact with the thermoplastic resin member has a high concentration of the carboxyl group or the phenol group reactive with the functional group present in the additive. For that reason, at the interface between the thermosetting resin member and the thermoplastic resin member, the number of chemical bonds between the carboxyl group or the phenol group in the surface layer and the functional group in the additive can be increased. This makes it possible to improve the adhesion between the thermosetting resin member and the thermoplastic resin member.

According to a second aspect of the present disclosure, the resin mold article includes a thermosetting resin member made of a thermosetting resin, and a thermoplastic resin member made of a thermoplastic resin and sealing a sealed surface which is a part of a surface of the thermosetting resin member. An exposed surface which is a remaining part of the surface of the thermosetting resin member is exposed to an outside of the thermoplastic resin member. A method for producing the resin mold article includes the following steps.

In the method for producing the resin mold article, at a curing molding step, a thermosetting resin material is prepared as a raw material of the thermosetting resin member, and the thermosetting resin member is formed by heating and curing the thermosetting resin material. At a surface layer formation step, at least one part of the sealed surface of the thermosetting resin member is transformed into a surface layer which is made of a thermosetting resin higher in concentration of a carboxyl group or concentration of a phenol group than the underlying thermosetting resin. At a plastic molding step, a thermoplastic resin material which is a raw material of the thermoplastic resin member is injection-molded on the thermosetting resin member having the surface layer, and the thermoplastic resin material containing an additive has a functional group which is capable of being chemically bonded to a functional group present in the surface layer. According to the injection molding, the sealed surface of the thermosetting resin member is sealed by the thermoplastic resin member while the carboxyl group or the phenol group present in the surface layer is chemically bonded to the functional group present in the additive added to the thermoplastic resin material.

According to the above configuration, the method for producing the resin molded article is provided, by which the resin molded article according to the first aspect can be appropriately produced. For that reason, the adhesion between the thermosetting resin member and the thermoplastic resin member can be improved.

### BRIEF DESCRIPTION OF THE DRAWINGS

FIG. 1 is a schematic cross-sectional view showing a semiconductor device as a resin molded article according to a first embodiment of the present disclosure.

FIG. 2 is a cross-sectional view showing a region R in the semiconductor device in FIG. 1.

FIG. 3 is an external perspective view schematically showing a thermosetting resin member in the semiconductor device in FIG. 1.

FIG. 4 is a schematic cross-sectional view showing a curing molding step in a method for producing a semiconductor device according to the first embodiment.

FIG. 5 is a schematic cross-sectional view showing a surface layer formation step in the method for producing the semiconductor device according to the first embodiment.

FIG. 6 is a schematic cross-sectional view showing the surface layer formation step subsequent to FIG. 5.

FIG. 7 is a schematic cross-sectional view showing a plastic molding step in the method for producing the semiconductor device according to the first embodiment.

FIG. 8 is a schematic cross-sectional view showing the plastic molding step subsequent to FIG. 7.

FIG. 9 is an external perspective view schematically showing a thermosetting resin member included in a semiconductor device as a resin molded article according to a second embodiment of the present disclosure.

### DESCRIPTION OF EMBODIMENTS

Hereinafter, multiple embodiments for implementing the present disclosure will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

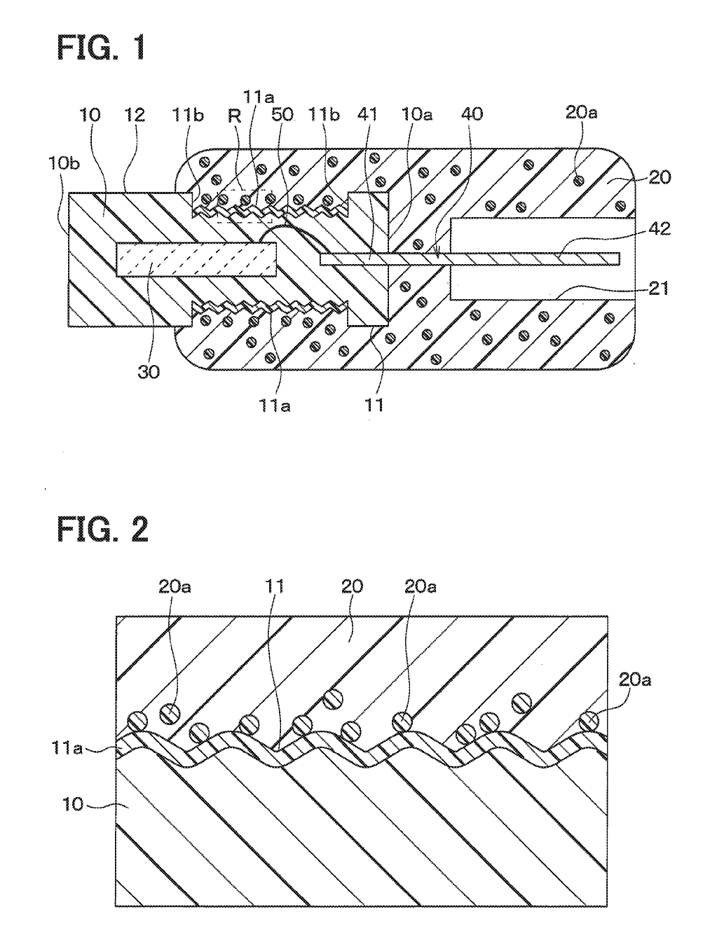

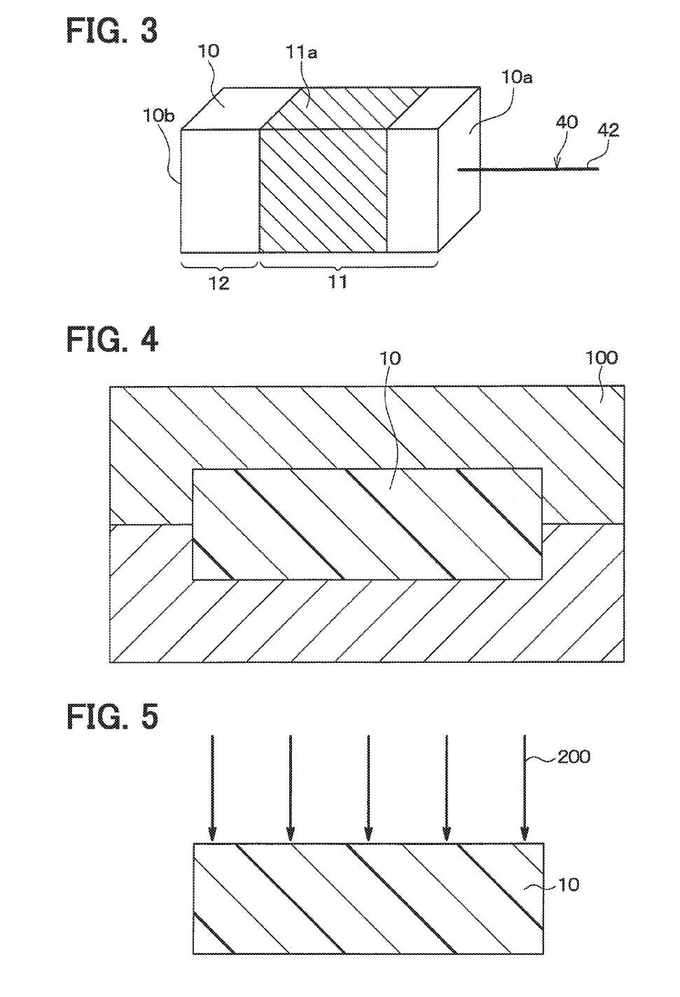

A resin molded article according to a first embodiment of the present disclosure will be described with reference to FIGS. 1 to 3. In FIG. 1, a thickness of a surface layer 11a formed on a surface of a thermosetting resin member 10, a height of a step 11b, and an additive 20a in a thermoplastic resin member 20 are illustrated with enlarged deformation for facilitation of understanding. Further, in FIG. 3, the surface layer 11a formed on the surface of the thermosetting resin member 10 is hatched with oblique lines on a surface of the surface layer 11a.

The resin molded article is mounted on a vehicle such as an automobile and is applied as a semiconductor device for driving various electronic devices for a vehicle. The semiconductor device as a resin molded article according to the present embodiment includes the thermosetting resin member 10 and the thermoplastic resin member 20 that seals a part of the surface of the thermosetting resin member 10.

The thermosetting resin member 10 is made of a thermosetting resin such as an epoxy resin and may optionally contain a filler made of an insulating material such as silica or alumina in the resin. Such a thermosetting resin member 10 is formed by performing transfer molding, compression molding, or molding by a potting method or the like, and a thermosetting treatment.

Further, the thermoplastic resin member 20 is made of a thermoplastic resin such as PPS (polyphenylene sulfide) or PBT (polybutylene terephthalate), and is subjected to injection molding so as to seal a part of the thermosetting resin member 10.

The thermoplastic resin member 20 seals a part of the surface of the thermosetting resin member 10 to provide a sealed surface 11 in which a part of the surface of the thermosetting resin member 10 is sealed with the thermoplastic resin member 20. The remaining part of the surface of the thermosetting resin member 10 other than the sealed surface 11 is an exposed surface 12 exposed to an outside of the thermoplastic resin member 20. The exposed surface 12 is exposed to the external of the thermoplastic resin member 20.

In this example, as shown in FIGS. 1 and 3, the thermosetting resin member 10 is configured as a rectangular parallelepiped block shape. A part of the surface of the thermosetting resin member 10 on one end 10a side of the thermosetting resin member 10 in a longitudinal direction is configured as the sealed surface 11 and the remaining part of the surface of the thermosetting resin member on the other end 10b side in the longitudinal direction is configured as the exposed surface 12.

More specifically, the thermosetting resin member 10 shown in FIGS. 1 and 3 has a rectangular parallelepiped having one longitudinal end face, the other end face opposed to the one longitudinal end surface, and four side surfaces extending in the longitudinal direction. The sealed surface 11 of the thermosetting resin member 10 is configured by one end face in the longitudinal direction and portions of the four side surfaces on one end 10a side in the longitudinal direction.

On the other hand, the exposed surface 12 of the thermosetting resin member 10 is configured by portions of the four side surfaces on the other end 10b side in the longitudinal direction.

The thermosetting resin member 10 internally includes a semiconductor device 30 as a first sealed component and an electric connection member 40 as a second sealed component, which are sealed with the thermosetting resin member 10.

The semiconductor device 30 as the first sealed component is configured by a sensor chip made of a silicon semiconductor or the like used for a magnetic sensor, a photosensor, a pressure sensor or the like. Such a semiconductor device 30 is formed by an ordinary semiconductor process.

For example, in the case of a semiconductor device 30 for the magnetic sensor, the entire semiconductor device 30 is sealed with the thermosetting resin member 10, and the semiconductor device 30 detects external magnetism through the thermosetting resin member 10.

Further, in the case of the semiconductor device 30 for the photosensor or the pressure sensor, an opening portion not shown for opening a part of the semiconductor device 30 is formed in the thermosetting resin member 10, and the semiconductor device 30 detects a light or a pressure through the opening.

On the other hand, the electric connection member 40 as the second sealed component is configured to electrically connect the semiconductor device 30 to a wiring member not shown outside of the semiconductor device. In this example, a part 41 of the electric connection member 40 is coated with the thermosetting resin member 10, and the remaining part 42 protrudes from the sealed surface 11 of the thermosetting resin member 10. The remaining part 42 of the electric connection member 40 is sealed by the thermoplastic resin member 20 outside of the thermosetting resin member 10 and a tip portion of the remaining part 42 is exposed to an outside of the thermoplastic resin member 20.

In this example, the part 41 of the electric connection member 40 is electrically connected to the semiconductor device 30 in the thermosetting resin member 10. The connection method with the semiconductor device 30 is not particularly limited, but in this example, the semiconductor device 30 is connected by a bonding wire 50 made of Al, Au or the like.

On the other hand, the thermoplastic resin member 20 seals the remaining part 42 of the electric connection member 40, but the thermoplastic resin member 20 is provided with an opening portion 21. In the opening portion 21, a further part of the remaining part 42 of the electric connection member 40 is exposed to the outside of the thermoplastic resin member 20.

The opening portion 21 of the thermoplastic resin member 20 is a portion into which an external wiring member not shown such as a connector member is inserted and connected. With the opening 21, the external wiring member and the electric connection member 40 are electrically connected to each other.

In other words, the electric connection member 40 functions as a device for detection, output, and so on of the semiconductor device 30, and the semiconductor device 30 enables an electrical exchange with the outside of the device through the electric connection member 40. In the present embodiment, a terminal configured by a rod-like member made of Cu, Al or the like is used as the electric connecting member 40, but a circuit board or the like may be used as the electric connection member 40.

In this example, as shown in FIGS. 1 to 3, a part of the sealed surface 11 of the thermosetting resin member 10 is configured as the surface layer 11a. The surface layer 11a is made of a thermosetting resin higher in concentration of a carboxyl group or concentration of a phenol group than the underlying thermosetting resin.

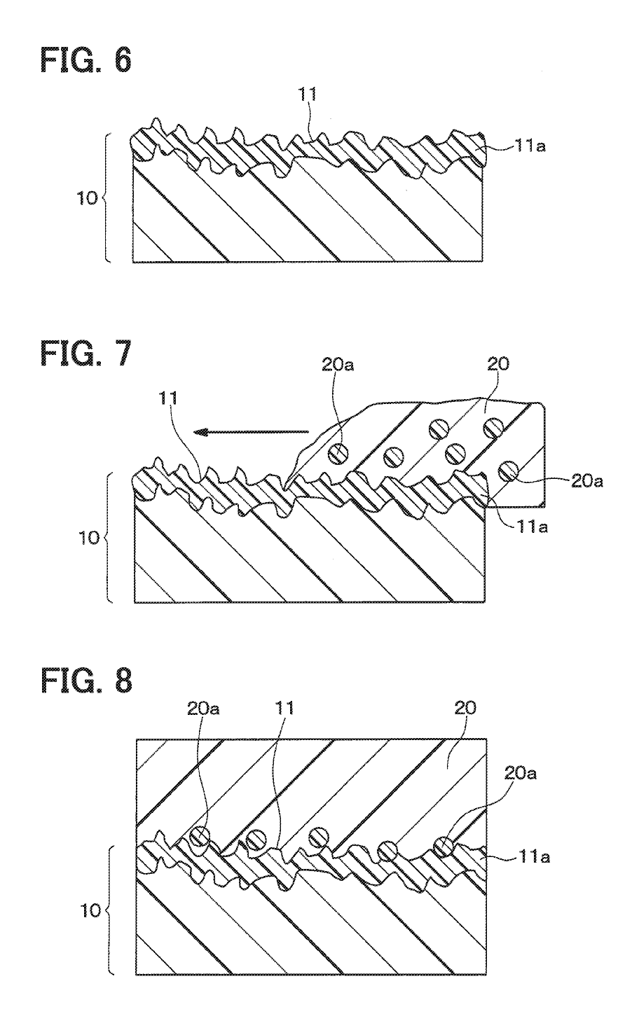

In this example, the surface layer 11a is formed by a surface layer formation step (refer to FIGS. 5 and 6), which will be described later. The surface layer 11a is configured by a layer obtained by modifying a surface portion of the thermosetting resin member 10 by chemical reaction with a laser, that is, a so-called laser reaction layer. In this example, as the laser, although not limited, for example, a CO2 laser, a YAG laser or the like is used.

Further, in the present embodiment, since a contaminant layer or the like on the surface of the thermosetting resin member 10 is removed by laser irradiation for forming the surface layer 11a, a newly generated surface is recessed. The recessed newly formed surface is activated by a laser energy into a portion where the concentration of the carboxyl group or the concentration of the phenol group is increased, and is formed as the surface layer 11a.

In this way, as shown in FIG. 1, a surface on which the surface layer 11a is formed in the surface of the thermosetting resin member 10 is recessed relative to a portion other than the surface on which the surface layer 11a is formed, and the step 11b is provided between the formation surface of the surface layer 11a and other portions. A height of the step 11b is several μm or more (for example, 5 μm or more).

The presence of the surface layer 11a is confirmed by observation of a plasmon loss image of FE-TEM (field emission type transmission electron microscope, English: Field Emission-Transmission Electron Microscope).

Although not limited, for example, in the case of the carboxyl group, the concentration of the carboxyl group in the underlying thermosetting resin is substantially 0%, whereas the concentration of the carboxyl group in the surface layer 11a is about several %. In this example, the concentration of the carboxyl group or the concentration of the phenol group in the surface layer 11a and the underlying portion is confirmed by dye XPS analysis (dyeing X-ray photoelectron spectroscopy, XPS is the abbreviation of X-ray photoelectron spectroscopy).

The thickness of the surface layer 11a is not limited, but is set to, for example, about several tens of ±m. In the present embodiment, the surface on which the surface layer 11a is formed is configured by a surface irradiated with laser as described above. The formation surface of the surface layer 11a is roughened by the laser irradiation into a roughened surface whose roughness degree (surface roughness) is larger than that of the sealed surface 11 and the exposed surface 12 other than the formation surface of the surface layer 11a. As shown in FIGS. 1 and 2, the surface layer 11a has a concavo-convex shape corresponding to the concavo-convex shape caused by the roughening.

In addition, the additive 20a is added in the thermoplastic resin member 20. The additive 20a is made of a polymer having any one or more functional groups including an epoxy group, a hydroxyl group, an amino group, a carbonyl group and the like. Although not limited, for example, the additive 20a is used as a main agent of the epoxy resin.

As shown in FIG. 2, at an interface between the surface layer 11a of the thermosetting resin member 10 and the thermoplastic resin member 20, a large amount of additive 20a in the thermoplastic resin member 20 is localized as compared with the portions other than the interface in the thermoplastic resin member 20. The localization of the additive 20a in the thermoplastic resin member 20 is confirmed by mapping analysis by EPMA (abbreviation of Electron Probe Micro Analyzer).

At the interface between the surface layer 11a and the thermoplastic resin member 20, the carboxyl group or the phenol group present in the surface layer 11a and the functional group present in the additive 20a are chemically bonded to each other. The chemical bond at the interface is caused by a chemical reaction of the functional group such as the epoxy group or the hydroxyl group in the additive 20a with the carboxyl group or the phenol group in the surface layer 11a. Although not particularly limited, the covalent bond such as an ether bond can be exemplified.

The chemical bond between the surface layer 11a and the additive 20a is confirmed by a peak wavelength of an FT-IR (the abbreviation of Fourier-transform infrared spectroscopy). For example, when the additive 20a is contained in the thermoplastic resin member 20 as shown in the above specific example, it is confirmed that a large amount of ether bond (C—O—C) exists as the chemical bond at the interface. In the case of containing no additive 20a, no ether bond is almost confirmed.

As described above, as shown in FIGS. 1 and 3, the remaining part 42 of the electric connection member 40, which is the second sealed component, protrudes from the sealed surface 11 of the thermosetting resin member 10, and is sealed with the thermoplastic resin member 20.

On the sealed surface 11 located between the exposed surface 12 and the remaining part 42 of the electric connection member 40 in the thermosetting resin member 10, the surface layer 11a described above is disposed around the remaining part 42 of the electric connection member 40 so as to form a continuous closed ring shape.

In this example, as shown in FIG. 3, the remaining part 42 of the electric connection member 40 protrudes from one end face of the rectangular parallelepiped thermosetting resin member 10. The arrangement pattern of the surface layer 11a is configured by a continuous dosed ring pattern over the four side surfaces of the rectangular parallelepiped thermosetting resin member 10.

In the present embodiment, as shown in FIGS. 1 and 3, the surface layer 11a is formed only in the sealed surface 11 of the thermosetting resin member 10, that is, only on the inside of the thermoplastic resin member 20. For that reason, an end portion of the surface layer 11a is located inside the thermoplastic resin member 20.

Next, a method for producing the semiconductor device according to the present embodiment will be described with reference also to FIGS. 4 to 8. First, In the curing molding step shown in FIG. 4, the thermosetting resin material is prepared as a raw material of the thermosetting resin member 10, and the thermosetting resin material is heated and completely cured to form the thermosetting resin member 10.

Specifically, in the curing molding step, the semiconductor device 30 and the electric connection member 40 connected by the bonding wire 50 are installed in a mold 100, and as shown in FIG. 4, sealed by transfer molding or compression molding, and further heated and cured. In this way, the thermosetting resin member 10 is completed. The curing molding step may be carried out by potting or the like.

A contaminant layer not shown made of contaminants is present on the outermost surface of the thermosetting resin member 10 formed in the curing molding step. In this example, the contaminant is, for example, a release agent or a foreign substance attached to the surface of the thermosetting resin member 10 during the process. The releasing agent is provided on the surface of the mold 100 or mixed with the thermosetting resin material itself in order to secure mold releasability in the molding, and is made of, for example, siloxane, fatty acid, or the like.

Next, as shown in FIGS. 5 and 6, a surface layer formation step is performed on the thermosetting resin member 10. In this step, a part of the sealed surface 11 of the thermosetting resin member 10, that is, a portion forming the surface layer 11a of the sealed surface 11 is modified with the chemical reaction into the surface layer 11a described above.

Specifically, in the present embodiment, as shown in FIG. 5, a portion forming the surface layer 11a of the sealed surface 11 in the thermosetting resin member 10 is irradiated with a laser 200. The portion irradiated with the laser 200 is chemically reacted with an energy of the laser 200, to thereby form the surface layer 11a as shown in FIG. 6.

As described above, at the time of laser irradiation, the contaminant layer located on the outermost surface is removed at a portion irradiated with the laser, so that the portion is recessed with the step 11b and roughened into a newly formed surface. The recessed newly formed surface is activated by the laser energy into the surface layer 11a.

In this way, after the surface layer formation step has been performed, a plastic molding step shown in FIGS. 7 and 8 is carried out. In the step, the thermoplastic resin material to which the additive 20a, which is the raw material of the thermoplastic resin member 20, is added is injection molded onto the sealed surface 11 of the thermosetting resin member 10 including the surface layer 11a.

The thermoplastic resin material to which the additive 20a is added can be obtained, for example, by kneading a polymer having a functional group to be the additive 20a into the thermoplastic resin material as a base material.

As a result, in the plastic molding step, while the high concentration carboxyl group or phenol group present in the surface layer 11a and the functional group present in the additive 20a contained in the thermoplastic resin material are chemically bonded to each other, the sealed surface 11 of the thermosetting resin member 10 is sealed with the thermoplastic resin member 20.

As the chemical bond in the plastic molding step, for example, in the case where the thermosetting resin member 10 is made of the epoxy resin, there is a chemical bond of the carboxyl group or phenol group in the surface layer 11a obtained by modifying the epoxy resin to the epoxy group, a hydroxyl group and the like present in the additive 20a. In this case, since the chemical bond is a covalent bond, the bond becomes stronger.

With the chemical bond, a high adhesion between the surface layer 11a of the thermosetting resin member 10 and the thermoplastic resin member 20 can be obtained. In this way, the plastic molding step is completed, and the semiconductor device as the resin molded article according to the present embodiment is completed.

Since each step after the surface layer formation step described above selectively processes a part of the surface of the thermosetting resin member 10, masking or the like is appropriately performed on the surface not subjected to the processing, and then each step is carried out.

Incidentally, according to the present embodiment, a part of the sealed surface 11 that comes in direct contact with the thermoplastic resin member 20 in the thermosetting resin member 10 is configured by the surface layer 11a. The surface layer 11a has the carboxyl group or the phenol group having high reactivity with the functional group present in the additive 20a at a high concentration.

For that reason, at the interface between the thermosetting resin member 10 and the thermoplastic resin member 20 through the surface layer 11a, the chemical bond between the carboxyl group or the phenol group in the surface layer 11a and the functional group in the additive 20a can be increased. For that reason, according to the present embodiment, the adhesion between the thermosetting resin member 10 and the thermoplastic resin member 20 can be improved.

Further, in the present embodiment, since the surface on which the surface layer 11a is formed is configured as the roughened surface as described above, the adhesion between the surface layer 11a and the thermoplastic resin member 20 is expected to be further improved due to an irregular shape of the roughened surface.

In the sealed state of the thermoplastic resin member 20 as in the present embodiment, entry substance such as moisture and contaminants from the outside may enter the device along the interface from the end portion of the interface between the thermosetting resin member 10 and the thermoplastic resin member 20, which is located at the boundary between the sealed surface 11 and the exposed surface 12. In particular, in the case of the vehicle semiconductor device as in the present embodiment, for example, contaminants such as moisture and oil present in the usage environment may enter the device.

At this time, as in the present embodiment, in the case where the remaining part 42 of the electric connection member 40 which is a sealed component protrudes from the sealed surface 11 of the thermosetting resin member 10 and is sealed with the thermoplastic resin member 20, there is a possibility that the entry substance adheres to the remaining part of the electric connection member 40 and adversely affects the characteristics and the like.

In this respect, in the present embodiment, the surface layer 11a is provided in the portion of the sealed surface 11 of the thermosetting resin member 10, which is located between the exposed surface 12 and the remaining part 42 of the electric connection member 40 protruding from the sealed surface 11, so as to form the dosed ring shape.

The portion of the ring closed shape is a portion in which a high adhesion is obtained as described above and separation is prevented. For that reason, according to the present embodiment, the entry substance described above can be prevented from being transferred from the exposed surface 12 side to the remaining part 42 of the electric connection member 40 through the interface between the two resin members 10 and 20, for example, from the left side to the right side in FIG. 1, as much as possible.

### Second Embodiment

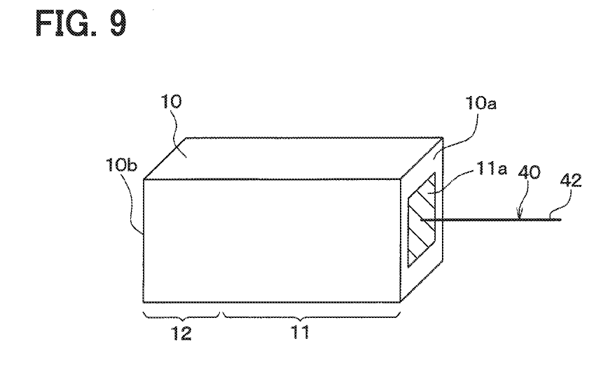

A semiconductor device as a resin molded article according to a second embodiment of the present disclosure will be described with reference to FIG. 9. The present embodiment is different from the first embodiment described above in that an arrangement pattern of a surface layer 11a of a thermosetting resin member 10 is changed, and the difference will be mainly described in the present embodiment.

In the first embodiment described above, as shown in FIG. 3, the arrangement patter of the surface layer 11a is configured by the continuous closed ring pattern over the four side surfaces of the rectangular parallelepiped thermosetting resin member 10. On the other hand, in the present embodiment, as shown in FIG. 9, a surface layer 11a is arranged only on an end surface on one end 10a side, that is, on one end face of a rectangular parallelepiped thermosetting resin member 10.

Also in this case, the arrangement pattern of the surface layer 11a has a closed ring shape surrounding the remaining part 42 of the electric connection member 40 protruding from the one end face which is the sealed surface 11. Also in this case, as in the first embodiment, the effects of the closed ring pattern are exerted.

In each of the embodiments described above, the surface layer 11a is configured as a laser reaction layer, but is not limited to the laser reaction layer if the surface layer 11a is made of the thermosetting resin higher in concentration of the carboxyl group or concentration of the phenol group concentration than the underlying thermosetting resin. For example, the surface layer 11a may be configured by a layer formed by light irradiation other than a laser which activates the surface of the thermosetting resin member 10.

In each of the embodiments described above, the surface layer 11a is provided on a part of the sealed surface 11 of the thermosetting resin member 10 as shown in FIGS. 1, 3, and 9. Alternatively, the surface layer 11a may be provided on the entire sealed surface 11. In other words, the surface layer 11a may be provided on at least a part of the sealed surface 11.

Further, even if the surface layer 11a is formed up to the exposed surface 12 in addition to the sealed surface 11, there is no problem. Further, the surface layer 11a may be formed on the entire surface of the thermosetting resin member 10.

In addition, in the case where the surface layer 11a is provided on a part of the sealed surface 11, the continuous ring-shaped arrangement pattern is preferable as described above. However, in addition to such a pattern, the surface layer 11a may be formed in an island shape on the sealed surface 11.

Further, in FIG. 1, because the surface layer 11a is structured to fall with an area of the sealed surface 11, the step 11b is sealed inside the thermoplastic resin member 20. On the other hand, the surface layer 11a may be extended continuously to a part of the exposed surface 12 beyond the sealed surface 11 of the thermosetting resin member 10. In that case, the step 11b may be exposed to an outside of the thermoplastic resin member and be visible.

In addition, the first sealed component and the second sealed component are not limited to the semiconductor device 30 and the electric connection member 40 or a circuit board if those sealed components can be sealed with the thermosetting resin member 10.

Further, a shape of the thermosetting resin member 10 is not limited to the rectangular parallelepiped shape described above, and may be a spherical shape, an undefined shape, or the like. The sealing configuration of the thermoplastic resin member 20 may be made in such a manner that a part of the surface of the thermosetting resin member 10 is sealed and the remaining part is exposed, and is not limited to the configuration in which one end 10a side of the thermosetting resin member 10 is the sealed surface 11 and the other end 10b side is the exposed surface.

In the embodiments described above, the resin molded article is the semiconductor device, and the semiconductor element 30 or the like as a sealed component which is sealed with the thermosetting resin member 10 is provided inside the thermosetting resin member 10. However, the resin molded article is not limited to such a semiconductor device, and for example, a configuration in which no sealed component is provided as the thermosetting resin member 10 may be applied.

The present disclosure is not limited to the above embodiments, but can appropriately change within a scope of the present disclosure. The above respective embodiments are not irrelevant to each other, and can be appropriately combined with each other except that the combination is clearly improper, and the respective embodiments are not limited to the above illustrated examples.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

1. A resin molded article comprising:
a thermosetting resin member made of a thermosetting resin; and
a thermoplastic resin member made of a thermoplastic resin and sealing a sealed surface which is a part of a surface of the thermosetting resin member, wherein
an exposed surface which is a remaining part of the surface of the thermosetting resin member is exposed to an outside of the thermoplastic resin member,
an additive having a functional group is added to the thermoplastic resin member,
the thermosetting resin member has a surface layer on at least a part of the sealed surface, and the surface layer being made of a thermosetting resin higher in concentration of a carboxyl group or concentration of a phenol group than the underlying thermosetting resin, and
the carboxyl group or the phenol group present in the surface layer is chemically bond to the functional group present in the additive.

2. (canceled)

3. The resin molded article according to claim 1, wherein the chemical bond between the carboxyl group or phenol group present in the surface layer and the functional group present in the additive is ether bond.

4. The resin molded article according to claim 1, further comprising a sealed component having a part coated with the thermosetting resin member, and a remaining part protruding from the sealed surface of the thermosetting resin member, wherein
the remaining part of the sealed component is sealed with the thermoplastic resin member, and
the surface layer is provided on the sealed surface of the thermosetting resin member located between the exposed surface and the remaining part of the sealed component, the surface layer forming a closed ring shape around the remaining part of the sealed component.

5. A method for producing a resin molded article, the resin mold article including:
a thermosetting resin member made of a thermosetting resin; and
a thermoplastic resin member made of a thermoplastic resin and sealing a sealed surface which is a part of a surface of the thermosetting resin member, wherein
an exposed surface which is a remaining part of the surface of the thermosetting resin member is exposed to an outside of the thermoplastic resin member, the method comprising:
a curing molding step including preparing a thermosetting resin material as a raw material of the thermosetting resin member, and forming the thermosetting resin member by heating and curing the thermosetting resin material;
a surface layer formation step including transforming at least one part of the sealed surface of the thermosetting resin member into a surface layer which is made of a thermosetting resin higher in concentration of a carboxyl group or concentration of a phenol group than the underlying thermosetting resin; and
a plastic molding step including injection-molding a thermoplastic resin material which is a raw material of the thermoplastic resin member on the thermosetting resin member having the surface layer, the thermoplastic resin material containing an additive having a functional group which is capable of being chemically bonded to a functional group present in the surface layer, thereby sealing the sealed surface of the thermosetting resin member with the thermoplastic resin member while chemically bonding the carboxyl group or the phenol group present in the surface layer to the functional group present in the additive added to the thermoplastic resin material.

6. The method for producing the resin molded article according to claim 5, wherein the surface layer formation step including irradiating the at least one part of the sealed surface of the thermosetting resin member with a laser such that the surface layer is formed via chemical reaction of the at least one part of the sealed surface by an energy of the laser.

7. The method for producing the resin molded article according to claim 5, wherein a chemical bond between the carboxyl group or phenol group present in the surface layer and the functional group present in the additive is ether bond.
